(19) United States
(12) Patent Application Publication
(10) Pub. No.: US 2025/0391261 A1
(43) Pub. Date: Dec. 25, 2025

(54) NETWORK DEVICE EVENT PROCESSING

(71) Applicant: ObjectVideo Labs, LLC, Tysons, VA (US)

(72) Inventors: Allison Beach, Leesburg, VA (US); John Daniel Riordan, Barcelona (ES)

(21) Appl. No.: 19/227,621

(22) Filed: Jun. 4, 2025

Related U.S. Application Data
(60) Provisional application No. 63/663,461, filed on Jun. 24, 2024.

(51) Int. Cl. G08B 25/10

(52) U.S. Cl. CPC G08B 25/10

(57) ABSTRACT

Methods, systems, and apparatus, including computer programs encoded on computer storage media, for processing event data on a device at a property. One of the methods includes determining, for sensor data maintained by a battery powered device at a property, whether the battery powered device or another device for the property should process the sensor data; and using a result of the determination whether the battery powered device or the other device should process the sensor data, sending an instruction to the battery powered device to cause the battery powered device to process the sensor data or send the sensor data to the other device.

### CROSS-REFERENCE TO RELATED APPLICATION

This application claims the benefit of U.S. Provisional Application No. 63/663,461, filed Jun. 24, 2024, the contents of which are incorporated by reference herein.

### BACKGROUND

Monitoring systems can include multiple sensors. Some examples of sensors can include cameras, motion detectors, and breaking glass detectors. Any of these sensors can be battery powered, hardwired, or a combination of both.

### SUMMARY

In general, one innovative aspect of the subject matter described in this specification can be embodied in methods that include the actions of determining, for sensor data maintained by a battery powered device at a property, whether the battery powered device or another device for the property should process the sensor data; and using a result of the determination whether the battery powered device or the other device should process the sensor data, sending an instruction to a component of the battery powered device to cause the battery powered device to process the sensor data or send the sensor data to the other device.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include, in response to determining that another device should process the sensor data, selecting, from a plurality of other devices that can process the sensor data and that do not include the battery powered device, the other device that should process the sensor data; and sending a second instruction to the other device a) that was selected from the plurality of other devices, and b) to cause the other device to process the sensor data.

In some implementations, each device from the plurality of other devices can execute a property security application that can analyze sensor data from a plurality of different types of sensors. Selecting the other device from the plurality of other devices can use data indicating, for at least some devices from the plurality of other devices, one or more attributes of the respective other device. Sending the second instruction can cause the respective property security application for the other device to process the sensor data.

In some implementations, the method can include maintaining, in memory, data that indicates an accuracy of at least some devices from the plurality of other devices. Selecting the other device from the plurality of other devices can use at least some of the data that indicates the accuracy of at least some devices from the plurality of other devices.

In some implementations, determining, for the sensor data maintained by the battery powered device, whether the battery powered device or the device should process the sensor data can use one or more of a transmission resource cost, a type of the sensor data, an identifier for the battery powered device, calibration data for the battery powered device, a potential event represented by the sensor data, a requested task for processing the sensor data, or a time period during which the sensor data was captured.

In some implementations, the method can include, in response to determining that another device should process the sensor data, determining a time period during which the other device should process the sensor data; and sending, to the other device, a second instruction that indicates the time period and causes the other device to process the sensor data during the time period.

In some implementations, the method can include, in response to determining that another device should process the sensor data, selecting, from a plurality of processing operations, a processing operation the other device should execute to process the sensor data; and sending, to the other device, a second instruction that indicates the processing operation and causes the other device to perform the processing operation on at least a portion of the sensor data.

In some implementations, determining whether the battery powered device or another device should process the sensor data can include determining, for the sensor data maintained by the battery powered device at the property, whether the battery powered device or another device that maintains a machine learning model trained using data specific to the property should process the sensor data. Sending the instruction can include sending the instruction to the component of the battery powered device to cause the battery powered device to send the sensor data to the other device for processing using the machine learning model trained using the data specific to the property.

In some implementations, sending the instruction can include sending the instruction to the component of the battery powered device at the property to cause the battery powered device to send the sensor data to the other device for processing using property specific data.

In some implementations, sending the instruction can include sending the instruction to cause the battery powered device to send the sensor data to the other device. The method can include sending, to the other device, a second instruction that indicates a processing priority for the sensor data to cause the other device to process the sensor data according to the processing priority.

In some implementations, the method can include determining, using data for the sensor data, the processing priority for the sensor data.

In some implementations, the method can include maintaining the sensor data and object detection data that indicates an object detected by the battery powered device using the sensor data. Determining, for the sensor data maintained by the battery powered device, whether the battery powered device or the device should process the sensor data can use the object detection data.

In some implementations, the method can include generating, by the battery powered device, the object detection data by detecting, using the sensor data, an object represented by the sensor data.

In some implementations, sending the instruction can include sending, by a first component of the battery powered device, the instruction to a second, different component of the battery powered device.

In some implementations, sending the instruction can include sending, by a third device, the instruction to the component of the battery powered device to cause the battery powered device to provide the sensor data to the other device.

In some implementations, the method can include the third device can be the same device as the other device.

In some implementations, the method can include receiving an advertisement signal that indicates whether the other device has computational capacity to process the sensor data. Determining, for the sensor data maintained by the battery powered device, whether the battery powered device or another device should process the sensor data can use the advertisement signal that indicates whether the other device has computational capacity to process the sensor data.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can reduce computational resource usage by devices that are battery powered, enabling the battery powered devices to have a longer battery life. This can occur particularly for battery powered devices for which regarding or replacing a battery is difficult. In some implementations, the systems and methods described in this specification can reduce computational processing time by processing data on a device for the property that is closer, network-wise, to the battery powered device than other systems, such as cloud systems. For instance, for latency-sensitive operations, a system would not have to wait for the data to be compressed, uploaded, processed, and a result returned over the internet, e.g., which at a minimum can take several seconds.

In some implementations, the systems and methods in this specification can increase data security, e.g., by storing potentially sensitive data on devices that are less likely to be stolen such as non-battery, e.g., alternating current, powered devices, or mobile phones. In some implementations, the systems and methods described in this specification can increase data security by storing data in an encrypted format that might be unavailable if the data were stored on a battery powered device. In some implementations, the systems and methods described in this specification can increase data security by storing, processing, or both, data on a device for a property, reducing a likelihood that sensitive data is transmitted over the Internet, stored on a cloud system, or both. In some implementations, the systems and methods described in this specification can perform more accurate operations by using a device for a property, e.g., that can be more customizable than generic processing by a cloud system that is for a large number of properties, such as millions of properties.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which sensor data for a battery powered device is optionally transmitted to another device at or otherwise for a property for processing.

FIG. 2 is a flow diagram of a process for determining a device to process sensor data.

FIG. 3 is a diagram illustrating an example of a property monitoring system.

Like reference numbers and designations in the various drawings indicate like elements.

### DETAILED DESCRIPTION

Some battery powered devices have limited access to additional power sources. For instance, battery powered sensors, such as doorbell cameras or other security cameras, might use a battery with a single charge for a long period of time. These devices might have limited functionality to adjust an amount of computational resources used when analyzing sensor data to reduce an amount of energy consumed during the analysis process. Some examples of computational resources include processors, memory, and battery energy. Given these limitations, the battery powered sensors generally cannot perform computationally complex operations using captured sensor data.

A battery powered sensor can communicate with one or more other devices on a network. The other devices can have more robust computation resources; power sources, e.g., batteries that are recharged or non-battery energy sources such as hard-wired power; or both. The battery powered sensor can send sensor data to at least one of the other devices for analysis.

Sometimes, the battery powered sensor, or another system, can determine to which of the other devices to send the sensor data for analysis. This can occur when a smart phone, as an example of one of the other devices, might be performing computationally complex operations for another task, e.g., a game, might have limited energy, e.g., when the battery is less than a threshold amount, or a combination of both. As a result, the battery powered sensor might not necessarily send all sensor data to the same device for processing but might select between different ones of the other devices. This can occur based on the type of sensor data for analysis, a potential event represented by the sensor data, a resource cost for transmitting data for analysis, or a combination of these. For instance, the battery powered sensor can include, with the sensor data, metadata that indicates information about the event to cause a recipient device to determine whether, when, how, or a combination of these, to process the sensor data.

Since the battery powered sensor provides sensor data to other devices for the same property, e.g., that are all managed for occupants of the property, the battery powered sensor can increase a likelihood that sensitive data is not accessed by a malicious actor. For instance, the battery powered sensor might be more likely to be stolen or damaged than other devices at the property, e.g., when the battery powered sensor is a camera attached to the exterior of a building in contrast to a smart phone for the property or a desktop computer in an office at the property. Instead of storing the sensor data in long term memory of the battery powered sensor, the battery powered sensor can provide the sensor data to a smart phone for the property which can maintain, e.g., when an operator of the smart phone opts in, the sensor data in a longer-term memory for analysis, training, or both. This can increase the security of the sensor data.

In this specification, a device can be for the property in any appropriate manner. For instance, the device can be physically installed at the property, such as a camera, a wireless router, or a television. The device can have an application installed on the device that enables the device to access sensor data captured at the property. In some examples, the device can receive alerts from a monitoring system that analyzes sensor data captured at the property.

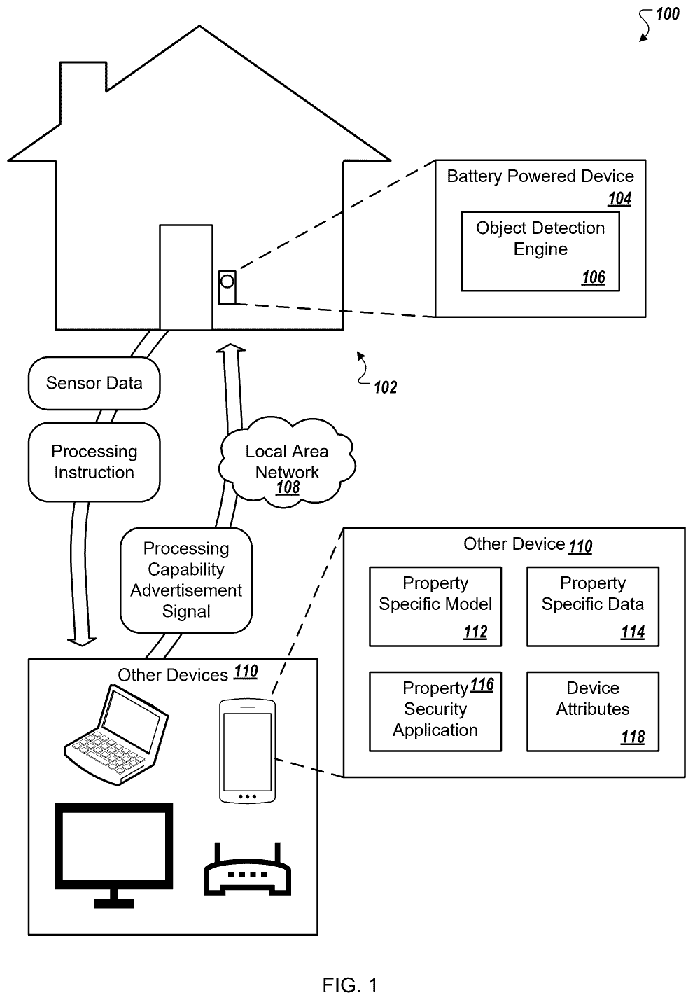

FIG. 1 depicts an example environment 100 in which sensor data for a battery powered device 104 is optionally transmitted to another device at or otherwise for a property 102 for processing. The battery powered device 104 can be any appropriate type of battery powered device, such as a camera, e.g., a doorbell camera. The battery powered device 104 can determine whether to offload processing of sensor data, captured by one or more sensors included in the battery powered device 104, to another device 110 connected to a local area network 108.

The battery powered device 104 has computational resources that do not satisfy a computational resource processing threshold for processing sensor data. For instance, the battery powered device 104 has a battery and does not have a hard-wired power source, e.g., an AC power source. The battery powered device 104 can have memory that does not satisfy one or more memory thresholds for storing a model to analyze the sensor data, e.g., the memory is too small given the size of the model. The model can be one of multiple models used to analyze the sensor data, the smallest of which might be able to be stored in the battery powered device's 104 memory. The battery powered device 104 can have a battery, a processor, memory, e.g., random access memory, a controller, a motherboard, and a network adapter, e.g., a wireless network adapter, to name a few examples of computational resources. The processor can be any appropriate type of processer, e.g., CPU, GPU, or a combination of both as a single device or separate devices. In some examples, the computational resources can include a transmission cost, e.g., to send data captured by the battery powered device 104 to the other device 110; a sensor data type; an identifier for the battery powered device 104; calibration data for the battery powered device 104; a potential event represented by the sensor data; an requested task for processing the sensor data; a time period during which the sensor data was captured; or a combination of two or more of these.

The potential event represented by the sensor data can include local processing to determine whether one or more event criteria are satisfied. For example, the battery powered device 104 can maintain a small database of biometric data for people who visit the property 102, e.g., members of the household. The size of the database is limited given the amount of memory included in the battery powered device 104. The battery powered device 104 can include a model, e.g., a specialized small neural network, that uses data from the database to determine whether one of the people is depicted in an image. When the battery powered device 104 determines that a person depicted in an image is not likely one of the people for whom the database maintains biometric data, the battery powered device 104 can determine that an event criterion is satisfied and to send corresponding sensor data to one of the other devices 110 for processing, as described in more detail below.

These computational resources, e.g., a combination of at least some of the resources or some of the resources alone, do not satisfy the computational resource processing threshold because the processing of the sensor data would consume too much of the battery for the required processing, preventing the battery from having at least a target life. Specifically, this would occur if the battery powered device 104 processed all captured sensor data using its own computational resources for the operations necessary to process the sensor data given one or more monitoring system processes for the property 102. These monitoring system processes can be defined for a monitoring system, e.g., as part of a security system for the property 102.

The battery powered device 104, or another device such as one of the other devices 110, can determine whether processing of the sensor data should be offloaded to another device connected to the local area network 108 for the property 102. The battery powered device 104 can use settings data, the computational resource processing threshold, or a combination of both, to determine whether to offload processing of the sensor data. For example, the device can determine whether the computational resource processing threshold is satisfied.

If the threshold is satisfied, the device can determine that the battery powered device 104 should process the sensor data. This can occur when the potential type of detected event is satisfies an event criterion, e.g., is not likely to require additional processing; given the type of operations required to process the sensor data, e.g., at the current processing stage; given a type of the battery powered device 104, e.g., a camera type or device type or both; when another device 110 for processing the sensor data is unavailable; or a combination of two or more of these. Another device 110 for processing the sensor data can be unavailable when the other devices 110 do not have power, do not have available computational resources for processing the sensor data, are not connected to the local area network 108, e.g., directly or indirectly, or a combination of two or more of these. For instance, when the battery powered device 104 determines that a smart phone is only indirectly connected to the local area network 108 and an amount of energy required to transmit the data to the smart phone satisfies a threshold amount, e.g., is about the same as or greater than an amount required to process the sensor data, the battery powered device 104 can determine to process the sensor data.

If the threshold is not satisfied, the device can determine that offloading of processing of the sensor data should be attempted. The device can send instructions, e.g., computer instructions as part of a message, to the battery powered device 104 to cause the battery powered device 104 to attempt offloading of the sensor data processing. The offloading process can be attempted in that sending the sensor data to the other device 110 is not guaranteed given the possibility of network disruptions and other events that might affect data transfer, e.g., if the other device turns off.

In some implementations, the device can select one of the other devices 110 to for processing the sensor data. For instance, in environments in which there is only one other device 110, e.g., a smart phone, the device can use that one other device for processing the sensor data. The device can use the one device given the lack of other devices, default device data that indicates the one other device as a default device for processing the sensor data, or another appropriate process.

In environments in which there are multiple other devices 110, the device can select one of those other devices 110 for processing the sensor data. The device can use any appropriate data, process, or combination of both, to select the other device for processing the sensor data. For instance, the device can use attribute data that indicates attributes of the one or more other devices 110, attributes about the sensor data, attributes about the local area network 108, other appropriate data, or a combination of two or more of these, when selecting the other device for processing the sensor data.

For example, the device can select the other device 110 that is hardwired to a power source; has the highest computational resources, e.g., a smartphone with a faster processor, more memory, or both; or a combination of these. Some examples of computational resources include access to additional hardware resources, additional compute resources, additional battery life, additional artificial intelligence, e.g., neural, processing resources, or a combination of these, that are not available to the battery powered device 104. In some examples, when a smart phone might have the highest computational resources of the other devices 110 but has a battery life that does not satisfy a battery threshold, the device can select a wireless router or a television as the other device for processing the sensor data when the latter other device has a hardwired power connection.

In some implementations, one or more of the other devices 110 can periodically transmit a processing capability advertisement signal. The processing capability advertisement signal can indicate one or more device attributes 118. The device attributes 118 can be any appropriate type of data, e.g., as described elsewhere in this specification as relates to data about one of the other devices 110. The device can use data from the processing capability advertisement signal when determining whether processing the sensor data should be offloaded, selecting a device for processing the sensor data, or both.

The battery powered device 104 can send the sensor data, one or more processing instructions, or both, to the selected other device 110. For instance, the battery powered device 104 can send the captured sensor data to the other device 110. The battery powered device 104 or another device that determined to offload processing of the sensor data, selected the other device for processing the sensor data, or a combination of both, can send the processing instruction to the selected other device 110.

Receipt of the processing instruction by the selected other device 110 causes the selected other device to process the sensor data. For instance, the processing instruction can be a general instruction that indicates that the sensor data should be processed or a specific instruction that indicates one or more operations to perform using at least some of the sensor data. The selected other device 110 can then perform one or more operations as part of the processing of the sensor data.

In some examples, the selected other device 110 can have a property specific model 112, property specific data 114, or both, stored in memory. The other device 110 can store one or both of the property specific model 112 or the property specific data 114 in an encrypted format, e.g., increasing data security. Receipt of the processing instruction can cause the selected other device 110 to use one or both of the property specific model 112 or the property specific data 114 when processing the sensor data.

For instance, the property specific model 112 can be a machine learning model trained specifically for the property 102, e.g., given particular types of events, people, or both, for the property. The other device 110 can update the property specific model 112 in response to detection of events at the property 102; using input from a person, e.g., indicating responses to notifications presented by the other device 110; using data from other devices for the property 102; or a combination of these. For instance, as a person is detected leaving for work at the same time on particular days of the week, e.g., Tuesday through Saturday, the other device 110 can update the property specific model 112 using that data. The property specific model 112 can be provided training data that represents a location at which the person parks their vehicle. As a result, the property specific model 112 is trained on data that is specific to the property 102 and that is potentially sensitive data.

The property specific data 114 can include data that is specific to the property 102, e.g., images of portions of the property; various types of personal information whether an image or schedule data or otherwise; a biometric model for detecting a specific person; other types of data for which there might be data privacy concerns; or a combination of these. A biometric model can be a model that represents an entity such as a person, a person's face, a vehicle, or an animal, e.g., pet. The entity can have a threshold likelihood of being at the property, e.g., a frequent visitor, an employee, or a resident. In some examples, the property specific data 114 can represent activity that occurs at the property 102 at least a threshold amount of time, e.g., normal activity at the property 102. In some examples, the property specific data 114 can represent activity that does not occur at the property 102 at least the threshold amount of time, e.g., abnormal activity at the property 102.

By maintaining one or both of the property specific model 112 or the property specific data 114 on the selected other device 110, the environment 100 can have increased data security, e.g., compared to environments in which some models or data is stored at a separate system, such as at the cloud.

The selected other device 110 can trigger one or more actions as a result of processing the sensor data. The actions can be any appropriate type of actions. For instance, the selected other device 110 can trigger one or more automated property actions, such as adjusting a temperature at the property, sounding an alarm, or presenting an alert, e.g., a visual or audible alert.

In some implementations, the other device 110 can use one or more settings to customize an action. For instance, the settings can indicate when an alert or another type of notification should be presented, how the notification can be presented, a custom action, e.g., given a particular detected event, custom automation triggers, an escalation process for an event, types of information that should be included in a notification for different types of events, or a combination of two or more of these.

A device can receive user input, e.g., in response to presenting information about an event for the property. For instance, the other device 110 can receive input in response to presentation of information about detection of a person approaching the property 102. The other device can use the user input to update the property specific model 112, the property specific data 114, or a combination of both.

By having one or both of the property specific model 112, or the property specific data 114, the other device 110 can more easily make updates specific to the property 102, devices for the property 102, people at the property 102, or a combination of these, compared to other systems. For instance, the updates can be easier because the other device would have access to a larger amount of data necessary for the update with fewer network communications in contrast to other systems that store the model, data, or both, at a different location, e.g., on the cloud. Updates for devices for the property 102 can include updates to respective models for different cameras physically installed at the property 102 so that those cameras more accurately detect events at the property 102. For example, since the other device 110, or a combination of devices for the property 102, maintain the property specific model 112, the property specific data 114, or both, these devices can more easily make updates to the corresponding features given a smaller amount of data required in contrast to a cloud-based system that would be required to manage a larger amount of data for multiple properties.

At least some of the other devices 110 can have a property security application 116 installed on the device. The selected other device 110 can use the property security application 116, e.g., a home security application, to process the sensor data. For instance, the property security application 116 can use the property specific model 112 to process the sensor data, e.g., and optionally at least a portion of the property specific data 114. In these examples, the property security application 116 can maintain the property specific model 112, the property specific data 114, or both, in memory.

In some examples, the property security application can execute a server process that receives the sensor data and the processing instruction. The received sensor data and processing instruction can be encrypted, e.g., by the battery powered device 104 or another device that sends the processing instruction to the selected other device 110. The selected other device 110 receives a message via a secure local channel. The message can include any appropriate type of, e.g., encrypted, data, such as the sensor data; the processing instruction; any existing processing results, e.g., fast-low quality object detection; metadata; or a combination of two or more of these. The metadata can include a timestamp, a camera identifier, calibration data, data indicating a requested task for processing the sensor data, or a combination of two or more of these. Although the selected other device 110 can receive data indicating a requested task, the selected other device 110 can perform any appropriate operations such as discarding the sensor data without performing the requested task, or performing additional non-requested processing, e.g., as determined by the property security application's 116 internal logic.

The environment 100 can have one or more features that enable opting into the offloading of processing sensor data from the battery powered. For instance, since the offloading might occur on devices that people use, such as a smart phone, laptop, or television, the environment 100 might require that a person opts into use of the sensor data offloading feature to use this feature. This can require opting in for specific devices or device types, e.g., in which case an opt in for offloading to a television or router would not automatically opt in offloading to a smart phone. In some examples, opting in can include opting in for all potential types of devices, e.g., that execute corresponding versions of the property security application 116.

As part of the opt in process, an interface can present information about potential benefits of the sensor data offloading. This can include an interface, e.g., on a smart phone, presenting information that indicates that opting in can extend the battery life of the battery powered device 104. The information can indicate that device selection for the offloading process would attempt to minimize impact on a user of the corresponding device, e.g., that sensor data processing would not be offloaded to a television while the television is in use or would not be offloaded to a smart phone while the smart phone is executing a game.

In some examples, the property security application 116 can present the interface. The interface can be audible, visible, or a combination of both. The interface can present the opt in process as part of a setup wizard for configuring the property security application 116, e.g., during an initial use of the property security application 116. In some examples, the configuration of the property security application 116 can include receipt of data for at least some of the device attributes 118, e.g., when the other device 110 can be used to process sensor data.

In some implementations, the battery powered device 104 can perform some analysis of the sensor data before a determination is made whether to offload additional processing of the sensor data to one of the other devices 110. For instance, when the battery powered device 104 is a camera, e.g., a doorbell camera, the battery powered device can include an object detection engine 106. The object detection engine 106 can analyze the sensor data to determine whether a candidate object of interest is detected in the sensor data, e.g., in a frame of a video sequence. A candidate object of interest can be any appropriate type of object that is not included in a threshold quantity of frames, e.g., part of the background content for the camera, such as a tree or a bush. Because general object detection can use fewer computational resources, e.g., compared to sending all sensor data across the local area network 108 to another device 110, the battery powered device 104 can perform this initial analysis. When the object detection engine 106 determines that a frame does not represent a candidate object of interest, the battery powered device 104 can determine to skip sending the sensor data to another device 110, e.g., saving computational resources such as battery life.

When the object detection engine 106 determines that a frame represents a candidate object of interest, a device can determine whether the camera should offload additional processing of the sensor data. The device can be the battery powered device 104, e.g., the camera, one of the other devices 110, or a cloud-based system. In implementations that use a cloud-based system, the battery powered device 104 might not provide any data that potentially has privacy concerns to the cloud-based systems and might provide property agnostic data, e.g., metadata, that enables the cloud-based system to determine whether processing should be offloaded. The property agnostic data can include data that indicates that an object was detected, that sensor data is available for processing, or a combination of both. The cloud-based system can use an identifier for the battery powered device 104, e.g., an anonymized identifier, to determine the one or more other devices 110 available to process the sensor data.

The device, e.g., the cloud-based system, can select one of the other devices 110 for processing the sensor data. For instance, the device can maintain a database that maps identifiers for battery powered devices to potential other devices 110 that can process sensor data. The device can determine which of the other devices are available, e.g., by sending an availability request to the other devices 110, sending an availability request to a selected other device 110, or a combination of these. Upon determining a selected other device 110 that is available to process the sensor data, the device can send a message to the battery powered device 104 that indicates the availability of the selected other device 110. Receipt of this message can cause the battery powered device to send the sensor data to the selected other device 110.

In some implementations, the processing instruction sent to the selected other device 110 can include priority data. The priority data can indicate a processing priority for the sensor data. The selected other device 110 can use the priority data to determine a priority for processing the sensor data, e.g., given other operations being performed by the selected other device 110. For instance, when the sensor data represents a potential security or emergency event, the priority data can indicate that processing the sensor data has a high priority. The selected other device 110 can detect the high priority indication for the sensor data and determine to process the sensor data sooner than if the priority data had a low priority indication. This can include suspending one or more other operations performed by the selected other device 110, assigning more computational resources to the processing of the sensor data, or a combination of both.

When the selected other device 110 is a battery powered device, the selected other device 110 satisfies one or more battery criteria. For instance, the selected other device 110 can have a battery with a longer life than the battery powered device, can be more likely to be charged than the battery powered device, or a combination of both.

The other devices 110 can include personal computers, mobile communication devices, televisions, wireless routers, security panels, and other devices that can send and receive data over the local area network 108, e.g., a Wi-Fi, Z-wave, or Bluetooth network. The local area network connects the battery powered device 104 and the other devices 110. Sometimes the local area network can connect to another network (not shown), wide area network (“WAN”), the Internet, or a combination thereof, for instance when transmitting data to or receiving data from a smartphone for the property 102, a cloud-based system, or a combination of both. In some implementations, at least some of the devices 104 and 110 can communication over a wide area network such as the Internet or a cloud-computing connection.

The devices 104 and 110 can include several different functional components, including the object detection engine 106, the property specific model 112, and the property security application 116. The object detection engine 106, the property specific model 112, the property security application 116, or a combination of these, can include one or more data processing apparatuses, can be implemented in code, or a combination of both. For instance, each of the object detection engine 106, the property specific model 112, and the property security application 116 can include one or more data processors and instructions that cause the one or more data processors to perform the operations discussed herein.

In some implementations, the property specific model 112, the property specific data 114, or a combination of both, can be transmitted between various devices for the property, e.g., the other devices 110. For instance, when a television is selected for processing the sensor data, another of the other devices 110 can transmit the property specific model 112 to the television to enable the television to process the sensor data.

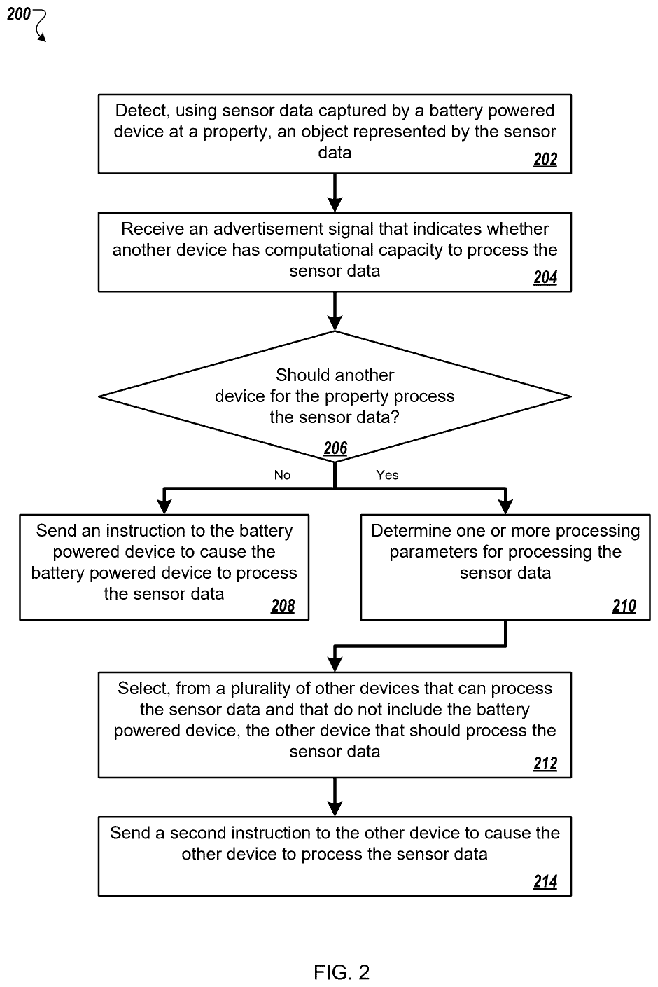

FIG. 2 is a flow diagram of a process 200 for determining a device to process sensor data. For example, the process 200 can be used by the battery powered device 104, the other device 110, or a combination of both, from the environment 100.

A device detects, using sensor data captured by a battery powered device at a property, an object represented by the sensor data (202). For instance, the battery powered device can use an object detection engine to detect the object.

In some examples, the device can perform other types of initial processing of sensor data. For example, a battery powered device can detect motion, changes in a region of interest, or detection of a particular type of object. A result of the initial processing of the sensor data can be a determination of a potential event type represented by the sensor data.

The device receives an advertisement signal that indicates whether another device has computational capacity to process the sensor data (204). For example, the device receives a signal that indicates that another device has computational capacity or is otherwise available to process the sensor data. When the device is a device that can process the sensor data, e.g., and is not the battery powered device that captured the sensor data, the device can detect its own availability to process the sensor data.

The device determines whether another device for the property should process the sensor data (206). For instance, the device can make this determination using the sensor data; task data that indicates one or more requested tasks for processing the sensor data; any received advertisement signals or other data that indicates availability of other devices; data that indicates computational resources of the other devices, the battery powered device, or both; a transmission resource cost for transmitting the sensor data, e.g., an energy cost; a type of the sensor data; a potential event represented by the sensor data; or a combination of two or more of these.

In some examples, the device can use a time period during which the sensor data was captured. For instance, the sensor data can more likely be offloaded during the night or times when the other devices are less likely to be used compared to during the day or evening when the other devices are more likely to be used. This can result in a lower likelihood of impacting a person's use of one of the other devices.

In some implementations, the device can use an identifier for the battery powered device. For instance, the device can use a mapping that indicates battery powered device identifiers and computational resource availability, an indication whether sensor data processing should be offloaded, other appropriate data, or a combination of these. When the device determines that the mapping indicates a higher likelihood for offloading sensor data, e.g., for a doorbell camera, the device is more likely to offload the sensor data processing than when the mapping indicates a lower likelihood for offloading sensor data, e.g., for an external camera with a larger battery.

The device can use calibration data for the battery powered device. For instance, the calibration data can indicate a camera's position, orientation, or both. The calibration data can indicate a known brightness for images captured by the camera. The calibration data can indicate other appropriate calibration parameters for the camera. The device can predict an amount of processing of the sensor data required. When the predicted amount of processing satisfies a processing criterion, the device can determine that processing of the sensor data should be offloaded to another device. When the predicted amount of processing does not satisfy the procession criterion, the device can determine that processing the sensor data might not need to be offloaded to another device, e.g., depending on other parameters that can be used in operation 206.

The device sends an instruction to the battery powered device to cause the battery powered device to process the sensor data (208). For instance, in response to determining that the other device should not be used to process the sensor data, the device can send the instruction to the battery powered device. When the device is the battery powered device, this operation can include a first component of the battery powered device sending the instruction to a second, different component of the battery powered device.

The device determines one or more processing parameters for processing the sensor data (210). For instance, in response to determining that another device should be used to process the sensor data, the device can perform one or more operations for the processing by the other device, e.g., one or more of operations 210, 212, or 214. The device can determine any appropriate type of processing parameters, such as a time period, a priority, a particular other device, or a combination of these, for processing the sensor data.

The time period can be any appropriate type period. For instance, the time period can be “within the next five minutes” or “before 2am”. The time period can be selected given the type of sensor data, the type of event potentially detected, other appropriate data, or a combination of these. The time period can indicate the time by which the other device should process the sensor data.

In some examples, as one of the processing parameters, the device can select, from a plurality of processing operations, a processing operation the other device should execute to process the sensor data. For instance, the device can determine a particular type of object recognition, e.g., person recognition or vehicle recognition, for the other device to perform using the sensor data.

The device selects, from a plurality of other devices that can process the sensor data and that do not include the battery powered device, the other device that should process the sensor data (212). For example, when there are multiple devices for the property that have availability to process the sensor data, the device can select one or more of the other devices for processing the sensor data. In some examples, when there is only a single device for the property that has availability to process the sensor data, the device selects that single device or skips operation 212, e.g., as there is only the single device.

The device sends a second instruction to the other device to cause the other device to process the sensor data (214). The second instruction can identify the sensor data, the requested tasks, the battery powered device, or a combination of these. In some examples, the device can send a first instruction to the battery powered device that causes the battery powered device to send the sensor data to the other device. Receipt of the second instruction can cause the other device to request the sensor data from the battery powered device. By having the other device request the sensor data, the process 200 can increase a likelihood that the other device is ready to process the sensor data, e.g., given other operations performed by the other device.

The order of operations in the process 200 described above is illustrative only, and determining the device to process the sensor data can be performed in different orders. For example, the process 200 can receive the advertisement (operation 204) and then detect the object (operation 202). In some examples, the process 200 can select the other device (operation 212) and then determine the one or more processing parameters (operation 210). When the process 200 includes both sending an instruction to the battery powered device and the second instruction to the other device, these operations can be performed in any order, at least partially concurrently, or a combination of both.

In some implementations, the process 200 can include additional operations, fewer operations, or some of the operations can be divided into multiple operations. For example, the process 200 can include operations 206 and 208. In some examples, the process 200 can include operations 206 and 214, optionally with one or both of operations 210 or 212. Any of these examples can include operation 204, 202, or both.

In some examples, operation 206 can include determining whether to process the sensor data with a machine learning model trained using data specific to the property, e.g., that was not the basis of training another model at another property. The property specific machine learning model can be stored at one of the other devices for the property, e.g., which device does not have a property specific model for another property such as would be included for a cloud-based system.

In some implementations, by processing the sensor data using the other device, the process 200 can include operations not enabled by other processes. For instance, if the other device processes the sensor data and detects an event of interest such as a suspicious person, the other device can send a request to other sensors at the property, e.g., within a threshold distance of the battery powered device, for sensor data. This can include a request for any nearby cameras to send all captured images for the next thirty seconds, e.g., even though the nearby cameras would normally only send images triggered by their own on device detectors.

In some implementations, some processing might be performed on a cloud system in addition to the other device, the battery powered device, or a combination of both. For instance, when the other device determines that a more robust model might be necessary for processing the sensor data, the other device can provide at least a portion of the sensor data or other data to the cloud system for processing.

In some implementations, the battery powered device can monitor offloaded operations. For instance, the battery powered device can include memory that implements a database. The battery powered device can store, in the database, statistics related to offloaded operations. The statistics can be any appropriate statistics, such as statistics about how many, what types of, or both, operations have been offloaded. In some examples, the statistics can indicate an estimated amount of battery life saved, e.g., an estimated hours of battery life saved. The statistics can indicate one or more of a list of known devices which can produce or consume computations; the computational abilities of at least some of these known devices (e.g. “produces raw images for detection”, “does basic motion detection on battery power”, “mains powered and has a GPU to do any AI task”); data that indicates which device performed what processing or what type of processing; accuracy data that indicates a predicted accuracy of processing performed by a device; a predicted computation time for a device; or any combination of these. In some examples, the database can be implemented on a different device or system, e.g., on the cloud.

The accuracy can be computed using any appropriate process, e.g., given feedback that indicates a false alert, a type of hardware on the device, or both. For example, the type of hardware can indicate a number of bits used in computations, and potential rounding errors given the number of bits. A processing device can be selected given the predicted accuracy of processing by that device. For instance, a higher accuracy device can be selected for processing of potentially more sensitive data, for processes for which accuracy might be more important, or both. A lower accuracy device can be selected for processing of potentially less sensitive data, for processes for which accuracy might be less important, or both.

The battery powered device can use the statistics for any appropriate process. For instance, the battery powered device, or another device associated with a property, can generate a message that causes presentation of a prompt that includes at least some of the statistics and a prompt about enabling more devices for processing the battery powered device's sensor data. For instance, the prompt can include a selectable user interface element that, upon selection, causes the system to add one or more additional devices for processing sensor data. When the statistics indicate a time when processing sensor data was offloaded, the one or more additional devices can be devices that are available to process sensor data at a different time. For example, when sensor data is normally offloaded during the evening and at night when a person with a smart phone is at the property, an additional device can be a television or a router or another device that is generally at the property during the day, e.g., that is always at the property.

In some instances, the battery powered device, or another device or system, can use the statistics when selecting the other device that should process the sensor data (e.g., as part of operation 212). For instance, the device or system can use statistics about processing devices, the types of data processed, or both, to select a processing device for a current set of sensor data.

In some examples, the battery powered device can generate statistics with test data. For instance, the battery powered device can maintain, in memory, test data for testing one or more network connected devices. The test data can be any appropriate type of data, e.g., sensor data of the same type that the battery powered device would generate during runtime. The battery powered data can transmit, to one or more of the network connected devices, the test data to cause the recipient device to process the data. The battery powered device can monitor the transmission, processing, or both, of the test data by the recipient device. The battery powered device can generate statistics using a result of the monitoring. These operations can occur when the battery powered device is first coupled to a network, a new device is identified for processing the battery powered devices sensor data, or both. The new device can be newly coupled to the network or previously coupled, e.g., and for which a setting was recently changed to indicate that the new device is allowed to process the sensor data. These statistics can include any appropriate type of statistics, e.g., battery energy consumed to transmit the test data, time taken for the recipient processing device to process the test data, or both. In some instances, theses statics can include data for the battery powered device, e.g., given different battery consumption in different environments.

For situations in which the systems discussed here collect personal information about people, or may make use of personal information, the people may be provided with an opportunity to control whether programs or features collect personal information (e.g., information about a person's activities, a person's preferences, or a person's current location), or to control whether and/or how the system operates. In addition, certain data may be anonymized in one or more ways before it is stored or used, so that personally identifiable information is removed. For example, a person's identity may be anonymized so that no personally identifiable information can be determined for the person, or a person's geographic location may be generalized where location information is obtained (such as to a city, ZIP code, or state level), so that a particular location of a person cannot be determined. Thus, the person may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

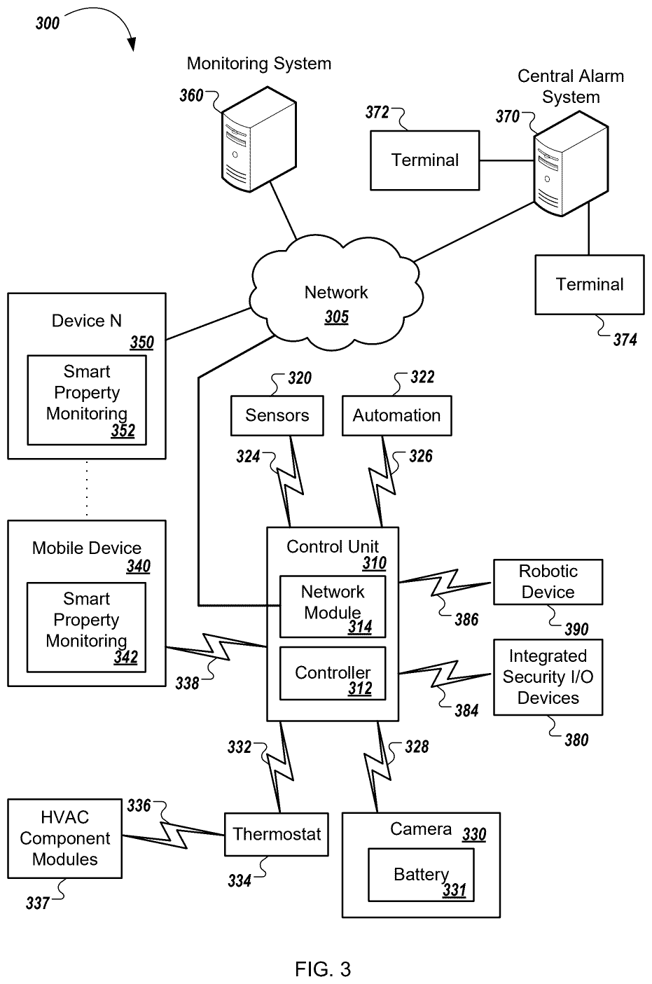

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm system 370, or a combination of two or more of these. In some examples, the network 305 facilitates communications between two or more of the control unit 310, the one or more devices 340 and 350, the monitoring system 360, and the central alarm system 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm system 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VOIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuously, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environment, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm system 370, or a combination of these, over the network 305. For example, the monitoring system 360 can be configured to monitor events (e.g., alarm events) generated by the control unit 310. In this example, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm system 370. For example, the monitoring system 360 can transmit the alert data to the central alarm system 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm system 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm system 370 can be configured to monitor alerting events generated by the control unit 310. In this example, the central alarm system 370 can exchange communications with the network module 314 included in the control unit 310 to receive information regarding alerting events detected by the control unit 310. The central alarm system 370 can receive information regarding alerting events from the one or more mobile devices 340 and 350, the monitoring system 360, or both. In some implementations, the central alarm system 370 can be implemented, at least in part if not entirely, on the monitoring system 360. In these implementations, the monitoring system 360 can perform the operations described with reference to the central alarm system 370.

The central alarm system 370 is connected to multiple terminals 372 and 374. The terminals 372 and 374 can be used by operators to process alerting events. For example, the central alarm system 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm system 370 and render a display of information using the alerting data.

For instance, the controller 312 can control the network module 314 to transmit, to the central alarm system 370, alerting data indicating that a sensor 320 detected motion from a motion sensor via the sensors 320. The central alarm system 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
determining, for sensor data maintained by a battery powered device at a property, whether the battery powered device or another device for the property should process the sensor data; and
using a result of the determination whether the battery powered device or the other device should process the sensor data, sending an instruction to a component of the battery powered device to cause the battery powered device to process the sensor data or send the sensor data to the other device.

2. The method of claim 1, comprising:
in response to determining that another device should process the sensor data, selecting, from a plurality of other devices that can process the sensor data and that do not include the battery powered device, the other device that should process the sensor data; and
sending a second instruction to the other device a) that was selected from the plurality of other devices, and b) to cause the other device to process the sensor data.

3. The method of claim 2, wherein:
each device from the plurality of other devices executes a property security application that can analyze sensor data from a plurality of different types of sensors;
selecting the other device from the plurality of other devices uses data indicating, for at least some devices from the plurality of other devices, one or more attributes of the respective other device; and
sending the second instruction causes the respective property security application for the other device to process the sensor data.

4. The method of claim 2, comprising:
maintaining, in memory, data that indicates an accuracy of at least some devices from the plurality of other devices, wherein:
selecting the other device from the plurality of other devices uses at least some of the data that indicates the accuracy of at least some devices from the plurality of other devices.

5. The method of claim 1, wherein determining, for the sensor data maintained by the battery powered device, whether the battery powered device or the device should process the sensor data uses one or more of a transmission resource cost, a type of the sensor data, an identifier for the battery powered device, calibration data for the battery powered device, a potential event represented by the sensor data, a requested task for processing the sensor data, or a time period during which the sensor data was captured.

6. The method of claim 1, comprising:
in response to determining that another device should process the sensor data, determining a time period during which the other device should process the sensor data; and
sending, to the other device, a second instruction that indicates the time period and causes the other device to process the sensor data during the time period.

7. The method of claim 1, comprising:
in response to determining that another device should process the sensor data, selecting, from a plurality of processing operations, a processing operation the other device should execute to process the sensor data; and
sending, to the other device, a second instruction that indicates the processing operation and causes the other device to perform the processing operation on at least a portion of the sensor data.

8. The method of claim 1, wherein:
determining whether the battery powered device or another device should process the sensor data comprises determining, for the sensor data maintained by the battery powered device at the property, whether the battery powered device or another device that maintains a machine learning model trained using data specific to the property should process the sensor data; and
sending the instruction comprises sending the instruction to the component of the battery powered device to cause the battery powered device to send the sensor data to the other device for processing using the machine learning model trained using the data specific to the property.

9. The method of claim 1, wherein:
sending the instruction comprises sending the instruction to the component of the battery powered device at the property to cause the battery powered device to send the sensor data to the other device for processing using property specific data.

10. The method of claim 1, wherein sending the instruction comprises sending the instruction to cause the battery powered device to send the sensor data to the other device, the method comprising:
sending, to the other device, a second instruction that indicates a processing priority for the sensor data to cause the other device to process the sensor data according to the processing priority.

11. The method of claim 10, comprising determining, using data for the sensor data, the processing priority for the sensor data.

12. The method of claim 1, comprising:
maintaining the sensor data and object detection data that indicates an object detected by the battery powered device using the sensor data,
wherein determining, for the sensor data maintained by the battery powered device, whether the battery powered device or the device should process the sensor data uses the object detection data.

13. The method of claim 12, comprising:
generating, by the battery powered device, the object detection data by detecting, using the sensor data, the object represented by the sensor data.

14. The method of claim 1, wherein:
sending the instruction comprises sending, by a first component of the battery powered device, the instruction to a second, different component of the battery powered device.

15. The method of claim 1, wherein:
sending the instruction comprises sending, by a third device, the instruction to the component of the battery powered device to cause the battery powered device to provide the sensor data to the other device.

16. The method of claim 15, wherein the third device is the same device as the other device.

17. The method of claim 1, comprising:
receiving an advertisement signal that indicates whether the other device has computational capacity to process the sensor data,
wherein determining, for the sensor data maintained by the battery powered device, whether the battery powered device or another device should process the sensor data using the advertisement signal that indicates whether the other device has computational capacity to process the sensor data.

18. A system comprising one or more computers and one or more storage devices on which are stored instructions that are operable, when executed by the one or more computers, to cause the one or more computers to perform operations comprising:
determining, for sensor data maintained by a battery powered device at a property, whether the battery powered device or another device for the property should process the sensor data; and
using a result of the determination whether the battery powered device or the other device should process the sensor data, sending an instruction to a component of the battery powered device to cause the battery powered device to process the sensor data or send the sensor data to the other device.

19. The system of claim 17, the operations comprising:
in response to determining that another device should process the sensor data, selecting, from a plurality of other devices that can process the sensor data and that do not include the battery powered device, the other device that should process the sensor data; and
sending a second instruction to the other device a) that was selected from the plurality of other devices, and b) to cause the other device to process the sensor data.

20. One or more non-transitory computer storage media encoded with instructions that, when executed by one or more computers, cause the one or more computers to perform operations comprising:
determining, for sensor data maintained by a battery powered device at a property, whether the battery powered device or another device for the property should process the sensor data; and
using a result of the determination whether the battery powered device or the other device should process the sensor data, sending an instruction to a component of the battery powered device to cause the battery powered device to process the sensor data or send the sensor data to the other device.
